(19) United States
(12) Patent Application Publication
(10) Pub. No.: US 2009/0049635 A1
(43) Pub. Date: Feb. 26, 2009

(54) COSMETIC RECOVERY TOOL

(76) Inventor: Marlene Mee, Oklahoma City, OK (US)

Correspondence Address: DUNLAP CODDING, P.C., PO BOX 16370, OKLAHOMA CITY, OK, 73113, US

(21) Appl. No.: 12/188,891

(22) Filed: Aug. 8, 2008

Related U.S. Application Data
(60) Provisional application No. 60/965,886, filed on Aug. 23, 2007.

(51) Int. Cl. B05C 17/10

(52) U.S. Cl. 15/236.07; 15/236.01

(57) ABSTRACT

A hand held cosmetic scraping/scooping tool for use in the recovery and removal of residual amounts of cosmetics (or other products), including, but not limited to, creams, shampoos, ointments, lotions, oils, pastes, powders, gels, liquids, solids, or semi-solids, from tubes, bags, bottles, including tall, narrow-top pump-top bottles, jars, canisters, cups, cans, boxes, or other containers. The scraping tool preferably has both a first scraping portion, and a second scraping portion each of which may be concave. In a preferred version, one end has a wider concave trough scooping portion with a rounded “L” shape at the end of it that is in a continuation trough configuration. The other end is narrower in width and without the “L” shape at the end but with the same concave trough shape. Both ends may be approximately the same length but preferably serve different purposes that work in accordance with the container size and the needs of the user. A middle section between the two scooping trough sections of the tool may be present and preferably has a space for a logo or commercial company name. These tools could be used for personal use as well as for professional use in retrieving creams and lotions from jars and containers to save contamination in hospitals, therapeutic and massage offices, medical centers, commercial sales, counters as well as in the home. The tool may be made of materials that can be sterilized.

### CROSS-REFERENCE TO RELATED APPLICATIONS

The present application claims the benefit under 35 U.S.C. 119(e) of U.S. Provisional Application Ser. No. 60/965,886, filed Aug. 23, 2007, the entirety of which is hereby expressly incorporated herein by reference.

### STATEMENT REGARDING FEDERALLY SPONSORED RESEARCH OR DEVELOPMENT

Not applicable.

### BACKGROUND OF THE INVENTION

A long standing problem with the use and application of cosmetics and similar products (such as creams, lotions and shampoos) is that it is often difficult to recover the final amount of the contents from the container after the bulk of the product has been removed. Containers (e.g., tubes, jars, pump-top bottles) of cosmetics and other semi-solid products often have creases, necks, grooves, corners, lips, bulges, or inaccessible bottoms that are difficult to access or reach thus much of the residual product is difficult to reach and remove. Further, pump-top bottles often leave a significant amount of product at the bottom where the end of the pump does not reach. This is especially problematic because cosmetics are often expensive and the waste or loss of even a few percent of the amount of the product within the container can result in a significant cost to the consumer. The consumer who wants to conserve the residual contents of the container often must resort to unwieldy and awkward measures to scrape or scoop the material from the container. Nothing has been available for retrieving product that would fit into small top openings or other difficult to reach areas, plus which is long enough to reach to the bottom as well as having a shape to fit into the corners at the bottom as well as scrape the sides to get all the product.

There is thus a need for a tool which is specifically designed and adapted for use with cosmetic containers (or containers of other desirable materials) to remove and conserve residual amounts of product therefrom.

### SUMMARY OF THE INVENTION

The present invention is a hand held cosmetic scooping/scraping tool preferably intended for the recovery and removal of residual amounts of cosmetics, including, but not limited to, creams, shampoos, ointments, lotions, oils, pastes, powders, gels, liquids, solids, or semi-solids, from tubes, bags, bottles, jars, canisters, cups, cans, boxes, or other containers. The containers may be rigid or flexible. The tool is used for scraping or scooping the material from the container. The tool can be used to remove not only cosmetic materials from a container, but may also be used to remove residual amounts of other desirable materials such as jellies, jams, peanut butters, pastes, spreads, and ice cream, for example. The scraping tool preferably has both a first scraping portion and a second scraping portion.

More particularly, in a preferred embodiment, the present invention is a long, thin, hand-held “L” shaped scraping tool preferably intended for the recovery and removal of residual amounts of product from difficult places with small or large openings, including, but not limited to lotions, creams, gels, shampoos, solids or semi-solids from tall or short pump-top bottles with small or large openings, tubes, jars, canisters, cups, cans, boxes, or other containers. The container may be rigid or flexible. The tool is used for scraping or scooping to retrieve the material from sides, corners and bottoms of containers that are tall or short, thin or fat. The tool can also be used to transfer the contents of one container to another in a safe and sterile manner. The tool can be used to remove not only creams, lotions, shampoos and other cosmetic materials from a container, but may also be used to remove residual amounts of other desirable materials such as food products. The scraping/retrieving tool is preferably made concave to hold product on either end. Preferably one end is slightly broader with a continuing curved “L” shape at the end to fit into and around corners to retrieve unreachable product. The other end of the tool is of the same approximate length, but preferably is slightly narrower and without the “L” shape. It is preferably of the same concave shape as the first end, and is designed to hold the product that is being retrieved. The center portion of the tool may be capable of being stamped or engraved with a commercial name, or the name of a gift recipient.

### BRIEF DESCRIPTION OF THE DRAWINGS

FIG. 1 is a top plan view of the scraping tool of the present invention.

FIG. 2 is a bottom plan view of the scraping tool of FIG. 1.

FIG. 3 is a longitudinal cross-sectional view of the tool of FIG. 1 taken along line 3-3.

FIG. 4 is a cross-sectional view taken along line 4-4 through a first scraping portion of the scraping tool of FIG. 1.

FIG. 5 is a cross-sectional view taken along line 5-5 through a second scraping portion of the scraping tool of FIG. 1.

FIG. 6 is a cross-sectional view taken along line 6-6 through a terminal portion of the second scraping portion of the scraping tool of FIG. 1.

FIG. 7 is a cross-sectional view of the tool of FIG. 1 taken along line 7-7 through a handle portion thereof.

FIG. 8 is a top plan view of an alternate embodiment of the tool of the present invention.

### DETAILED DESCRIPTION OF THE INVENTION

The present invention is a hand held cosmetic scooping/scraping tool preferably intended for the recovery and removal of residual amounts of cosmetics, including, but not limited to, creams, ointments, lotions, shampoos, oils, pastes, powders, gels, liquids, solids, or semi-solids, from tubes, bags, bottles, including tall, narrow-top pump-top bottles, jars, canisters, cups, cans, boxes, or other containers. The containers may be rigid or flexible. The tool is used for scraping or scooping the material from the container. The tool can be used to remove not only cosmetic materials from a container, but may also be used to remove residual amounts of other desirable materials such as jellies, jams, peanut butters, pastes, spreads, and ice cream, for example. The scraping tool preferably has both a first scraping portion and a second scraping portion as described in further detail below.

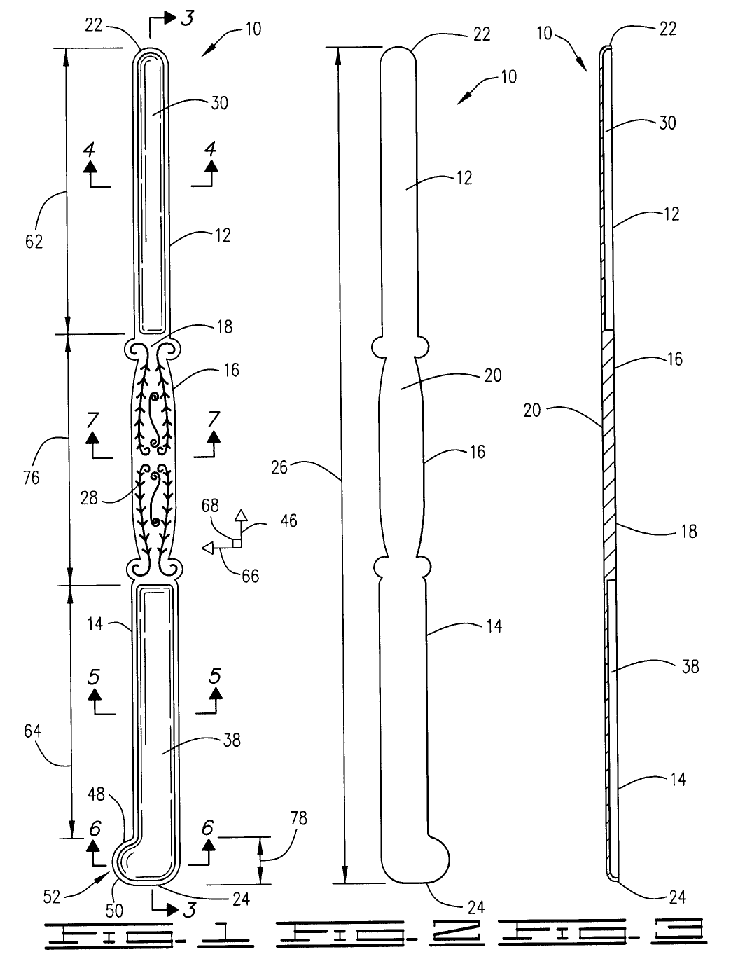

Referring now to the drawings, shown in FIGS. 1-3 is a scraping tool of the present invention, designated therein by the general reference numeral 10. Tool 10 in one embodiment comprises a first scraping portion 12, a second scraping portion 14, and a handle 16 disposed therebetween which connects the first scraping portion 12 and the second scraping portion 14. In one embodiment the first scraping portion 12 and/or the second scraping portion 14 may be detachable from the handle 16. The tool 10 has an upper side 18 (shown in FIG. 1), a lower side 20 (shown in FIG. 2), a first end 22 (comprising a terminal portion of the first scraping portion 12), and a second end 24 (comprising a terminal portion of the second scraping portion 14). The tool 10 has a length 26 which extends from the first end 22 to the second end 24. The handle 16 optionally has a design feature 28 engraved or printed on a surface thereof.

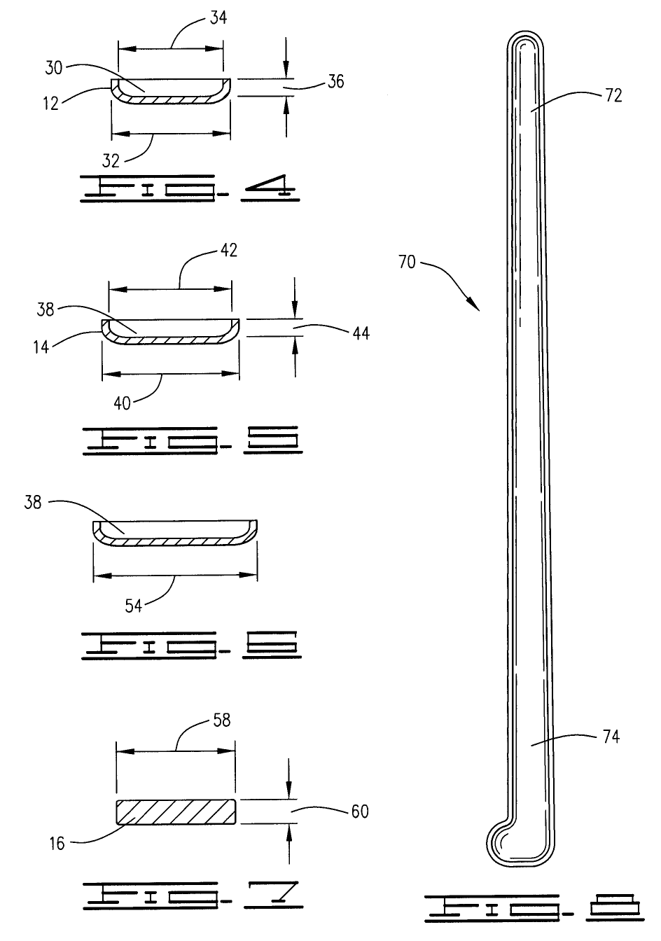

The first scraping portion 12 has an interior portion designated as first trough 30. As shown in FIG. 4, the first scraping portion 12 has a curved shape in cross-section such that the first trough 30 has a concave shape for accumulating and containing the residual product which is scraped or removed from the interior of the container of interest (such as a bottom or corner of the container). The first scraping portion 12 has an exterior width 32, an interior width 34, and a depth 36. The second scraping portion 14 also has an interior portion designated as second trough 38 and also has a curved shape in cross-section such that the second trough 38 also has a concave shape (FIG. 5) for accumulating and containing the residual product removed from the container of interest. The second scraping portion 14 has an exterior width 40, an interior width 42, and a depth 44. The second scraping portion 14 has a longitudinal axis 46. At the second end 24 of the tool 10, in a terminal portion of second scraping portion 14, a trough extension 48 has an axis 66 which extends at an angle 68 to the longitudinal axis 46 of the second scraping portion 14. The angle 68 is preferably a right angle (90°) but the angle 68 may be from 60° to 120°, or from 75° to 105° or more preferably from 85° to 95°. The trough extension 48 has a curved end 50 and an exterior width 78 of 3/16 (0.1875) inch to ½ (0.5) inch and an exterior length 54. Together the second trough 38 and trough extension 48 form an “L-shaped” trough 52 which optimizes the ability of the tool 10 to be used to reach under a rim or neck of a container or to reach into a cavity, groove, corner, crease, or bulge within the container. The exterior length 54 of trough extension 7/16 (0.4375) inch to 1 inch (see FIG. 6), and has a depth which is preferably the same as depth 44. Shown in FIG. 7, the handle 16 has a width 58 and a height 60. In an alternate embodiment the first scraping portion 12 and second scraping portion 14 may have an angular cross-sectional shape, rather than curved, such that the cross-section is angular, such as “v-shaped.”

The dimensions of length, width, and depth of the tool 10 can vary but are preferably sized for use with containers typically used to contain cosmetics. Such containers are numerous and are widely known in the art and commercially available but typically are sized to contain from 5 to 500 grams of material.

Preferably, the length 26 of the tool 10 of the present invention is from 6 to 12 inches and the exterior widths 32, 40 and 58 are from ¼ (0.25) inch to ¾ (0.75) inch. The exterior width 40, although exterior widths 40 and 32 may be equal, of the second scraping portion 14 is generally ¼ (0.25) inch to ½ (0.5) inch greater than exterior width 32 thereof. The length 26 is more preferably 8 to 11 inches, still more preferably 9 to 10½ (10.5) inches, and most preferably from 9½ (9.5) inches to 10 inches. The exterior width 32 is more preferably 5/16 (0.3125) inch to 7/16 (0.4375) inch. The exterior width 40 is more preferably 5/16 (0.325) inch to ⅝ (0.625) inch. The exterior width 58 is more preferably 7/16 (0.4375) inch to 9/16 (0.5625) inches. The depths 36 and 44 are preferably in the range of from 1/16 (0.0625) inch to ¼ (0.25) inch, and more preferably ⅛ (0.125) inch to 3/16 (0.1875) inch.

The first scraping portion 12 has a length 62 which is preferably in the range of 2½ (2.5) inches to 6 inches. Similarly the second scraping portion 14 has a length 64 which preferably is in a range of 2½ (2.5) inches to 6 inches. Preferably lengths 62 and 64 are each 3 to 4½ (4.5) inches and more preferably are each 3½ (3.5) inches to 4 inches and most preferably are each about 3½ (3.5) inches. The handle 16, when present, preferably has a length 76 which is in a range of 1 to 5 inches. As noted above each first scraping portion 12 and second scraping portion 14 may be removable from the handle 16 and replaceable with another similar, or different, implement.

The handle 16, though shown in the embodiment of FIGS. 1-7 is optional and alternative versions of the invention such as the scraping tool 70 shown in FIG. 8 may be constructed without a distinct handle between a first scraping portion 72 (having a straight trough) and a second scraping portion 74 (having an L-shaped trough).

The tool 10 may be constructed of any suitable material, including but not limited to plastics, thermoplastics, polymeric materials, wood, cellulose, glass, ceramic, and metals, particularly steel, aluminum, bronze, brass, copper, silver and gold, and plated materials, such as chrome and nickel-plate and may be rigid, flexible, or semi-flexible.

While the invention is described in connection herein with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, these following examples, which include preferred embodiments, serve to illustrate the practice of this invention, it being understood that the particulars shown are by way of example and for purposes of illustrative discussion of preferred embodiments of the present invention only.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process and apparatus described in the specification. As one of ordinary skill in the art will readily appreciate from the disclosure of the present invention processes and apparatus presently existing or later to be developed that perform substantially the same function or achieve substantially the same result as the corresponding embodiments described herein may be utilized according to the present invention. Accordingly, the appended claims are intended to include within their scope such processes and apparatus.

What is claimed is:

1. A cosmetic recovery tool, comprising:
a first scraping portion comprising a first trough portion which is substantially linear and terminates in a rounded end, and;
a second scraping portion comprising a second trough portion which is substantially linear, and a trough extension extending from the second trough portion at an angle to a longitudinal axis of the second trough portion such that the second scraping portion has an L-shape.

2. The cosmetic recovery tool of claim 1 having an overall length of 6 to 12 inches.

3. The cosmetic recovery tool of claim 1 further comprising:
a handle portion positioned between the first scraping portion and the second scraping portion and connecting the first scraping portion to the second scraping portion.

4. The cosmetic recovery tool of claim 3 wherein the handle has a length of 1 to 5 inches.

5. The cosmetic recovery tool of claim 1 wherein the first trough portion and second trough portions are concave.

6. The cosmetic recovery tool of claim 1 constructed from plastic, thermoplastic, polymeric material, wood, cellulose, glass, ceramic, metal, or combinations thereof.

7. The cosmetic recovery tool of claim 1 constructed of a rigid material.

8. The cosmetic recovery tool of claim 1 constructed of a flexible or semi-flexible material.

9. The cosmetic recovery tool of claim 1 wherein the first scraping portion has a length of 2.5 inches to 6.0 inches, and an exterior width of 0.25 inch to 0.75 inch, and wherein the first trough portion has a depth of 0.0625 inch to 0.25 inch.

10. The cosmetic recovery tool of claim 1 wherein the second scraping portion has a length of 2.5 inch to 6.0 inches, and an exterior width of 0.25 inch to 0.75 inch, and wherein the first trough portion has a depth of 0.0625 inch to 0.25 inch.

11. A method of removing a residual amount of a cosmetic material from a container, comprising:
providing a cosmetic recovery tool, the cosmetic recovery tool comprising:
a first scraping portion comprising a first trough portion which is substantially linear and terminates in a rounded end, and,
a second scraping portion comprising a second trough portion which is substantially linear, and a trough extension extending from the second trough portion at an angle to a longitudinal axis of the second trough portion such that the second scraping portion has an L-shape;
inserting the cosmetic recovery tool into an interior of the container; and
scraping a portion of the residual amount of cosmetic product from the interior of the container.

12. The method of claim 11 wherein the interior of the container comprises a corner and/or bottom of the container.
